(19) United States
(12) Patent Application Publication
(10) Pub. No.: US 2012/0063061 A1
(43) Pub. Date: Mar. 15, 2012

(54) Electrolyte solution composition and energy storage device including the same

(75) Inventors: Sang Kyun Lee, Gyeonggi-do (KR); Bae Kyun Kim, Gyeonggi-do (KR); Ji Sung Cho, Gyeonggi-do (KR)

(73) Assignee: Samsung Electro-Mechanics Co., Ltd., Suwon (KR)

(21) Appl. No.: 13/137,705

(22) Filed: Sep. 6, 2011

(30) Foreign Application Priority Data
Sep. 6, 2010 (KR) 10-2010-0087118
Aug. 9, 2011 (KR) 10-2011-0079166

(51) Int. Cl. H01G 9/145; H01G 9/035

(52) U.S. Cl. 361/505; 252/62.2

(57) ABSTRACT

Disclosed herein are an electrolyte solution composition and an energy storage device including the same. The electrolyte solution composition contains: a lithium salt including lithium ions; and a solvent made of a material selected from a group consisting of at least one cyclic carbonate compound and propionate compound. The electrolyte solution composition may balancedly maintain characteristics at a room temperature and a low temperature and be used for pre-doping lithium ions, thereby making it possible to improve pre-doping efficiency.

### CROSS REFERENCE(S) TO RELATED APPLICATIONS

This application claims the benefit under 35 U.S.C. Section 119 of Korean Patent Applications Serial Nos. 10-2010-0087118 and 10-2011-0079166, entitled “Electrolyte Solution Composition and Energy Storage Device Including the Same” filed on Sep. 9, 2010 and Aug. 9, 2011, which is hereby incorporated by reference in its entirety into this application.

### BACKGROUND OF THE INVENTION

1. Technical Field

The present invention relates to an electrolyte solution composition and an energy storage device including the same, and more particularly, to an electrolyte solution composition capable of increasing a capacitance and a lifespan of an energy storage device and reducing a resistance, and an energy storage device including the same.

2. Description of the Related Art

A stable supply of energy has been important factor in various electronic products such as information communication apparatus. Generally, this function is performed by a capacitor. That is, the capacitor serves to store and supply electricity in circuits of the information communication apparatus and various electronic products, thereby stabilizing a flow of electricity in the circuits. A general capacitor has a very short charging/discharging time, a long lifespan, and a high output density, but has a low energy density. Therefore, it has a limitation in being used as a storage device.

Meanwhile, a device referred to as an ultracapacitor or a supercapacitor has been prominent as a next-generation storage device due to rapid charging/discharging speed, high stability, and environment-friendly characteristics. A general supercapacitor is configured of an electrode structure, a separator, an electrolyte solution, and the like. The supercapacitor is driven based on an electrochemical mechanism that carrier ions in the electrolyte solution are selectively adsorbed to the electrode by applying a power to the electrode structure. As representative super capacitors, an electric double layer capacitor (EDLC), a pseudocapacitor, a hybrid capacitor, and the like are currently used.

The electric double layer capacitor is a supercapacitor that uses an electrode made of activated carbons and uses an electric double layer charging as a reaction mechanism. The pseudocapacitor is a supercapacitor which uses a transition metal oxide or a conductive polymer as an electrode and uses pseudo-capacitance as a reaction mechanism. The hybrid capacitor is a supercapacitor having intermediate characteristics between the electric double layer capacitor and the pseudocapacitor.

As the hybrid capacitor, a lithium ion capacitor (LIC) which uses a cathode made of activated carbons and an anode made of graphite and uses lithium ions as carrier ions to have high energy density of a secondary battery and high output characteristics of the electric double layer capacitor has been prominent.

The lithium ion capacitor contacts an anode material capable of absorbing and separating the lithium ions to a lithium metal and absorbs or dopes the lithium ions in the anode in advance using a chemical method or an electrochemical method, thereby lowering potential of the anode to enlarge withstanding voltage and considerably improving the energy density.

However, when an electrolyte solution that has been used in the secondary battery according to the related art is used, as it is, in a lithium ion capacitor, a capacitance is rapidly decreased and a resistance is rapidly increased at a low temperature, such that output characteristics are decreased.

Therefore, in an energy storage device such as a lithium ion capacitor, the development of a technology for implementing improved capacitance or resistance characteristics as compared to the related art even at a low temperature is currently being demanded.

### SUMMARY OF THE INVENTION

An object of the present invention is to provide an electrolyte solution composition capable of improving low-resistance and low-temperature characteristics, and an energy storage device including the same.

According to an exemplary embodiment of the present invention, there is provided an electrolyte solution composition of an energy storage device, the electrolyte solution composition containing: a lithium salt including lithium ions; and a solvent made of a material selected from a group consisting of at least one cyclic carbonate compound and propionate compound.

The lithium salt may contain at least any one of LiPF₆, LiBF₄, LiSbF₆, LiAsF₅, LiClO₄, LiN, CF₃SO₃, and LiC.

The lithium salt may be 1.0 mol/L to 1.5 mol/L of LiPF₆.

The solvent may contain ethylene carbonate (EC), propylene carbonate (PC), and methyl propionate (MP).

The ethylene carbonate, the propylene carbonate, and the methyl propionate may have a weight ratio of 3±0.05:1±0.02:4±0.05.

According to another exemplary embodiment of the present invention, there is provided an energy storage device including: a case; an anode and a cathode disposed to be spaced apart from each other in an inner portion of the case; a separator separating the anode and the cathode from each other in the inner portion of the case; and an electrolyte solution composition filled in the inner portion of the case, wherein the electrolyte solution composition contains: a lithium salt including lithium ions; and a solvent made of a material selected from a group consisting of at least one cyclic carbonate compound and propionate compound.

The lithium salt may contain at least any one of LiPF₆, LiBF₄, LiSbF₆, LiAsF₅, LiClO₄, LiN, CF₃SO₃, and LiC.

The lithium salt may be 1.0 mol/L to 1.5 mol/L of LiPF₆.

The solvent may contain ethylene carbonate (EC), propylene carbonate (PC), and methyl propionate (MP).

The ethylene carbonate, the propylene carbonate, and the methyl propionate may have a weight ratio of 3±0.05:1±0.02:4±0.05.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein.

These embodiments may be provided so that this disclosure will be thorough and complete, and will fully convey the scope of the invention to those skilled in the art.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an electrolyte solution composition according to an exemplary embodiment of the present invention will be described in detail.

The electrolyte solution composition according to the exemplary embodiment of the present invention contains a lithium salt and a solvent.

Here, as the lithium salt, LiPF₆, LiBF₄, LiSbF₆, LiAsF₅, LiClO₄, LiN, CF₃SO₃, LiC, and the like, may be used.

Meanwhile, the solvent constituting the electrolyte solution composition according to the exemplary embodiment of the present invention may contain a mixture of materials selected from a group consisting of cyclic carbonate compounds and propionate compounds.

Particularly, an example of the cyclic carbonate compound may contain ethylene carbonate (EC) and propylene carbonate (PC), and an example of the propionate compound may contain methyl propionate.

### Experimental Example 1

In order to analyze characteristics of an electrolyte solution composition, activated carbon having a specific surface area of 2000 m²/g was coated at a thickness of 60 μm on a current collector to thereby be used as a cathode, and hard carbon having a specific surface area of 10 m²/g was coated at a thickness of 25 μm on the current collector to thereby be used as an anode.

In addition, in a composition of an electrolyte solution, 1.0 to 1.5 mol/L of LiPF₆ was used as a solute and a material having the following composition ratio: EC:PC:MP=3±0.05:1±0.02:4±0.05 was used as a solvent according to the present invention (Example 1).

In order to perform comparison with characteristics of an electrolyte solution according to Example of the present invention, Control Groups in which 1.2 mol/L of LiPF₆ is used as a solute and materials containing the following three composition ratios are used as a solvent were prepared and then tested.

(Control Group 1) EC:PC=3:5

(Control Group 2) EC:PC=7:1

(Control Group 3) EC:PC:ethyl methyl carbonate (EMC)=3:1:4

Results shown in the following Table 1 were obtained by measuring capacitances (F) and resistances Ω at temperatures of 25° C. and −40° C. with respect to Example 1 and Control Groups 1 to 3.

TABLE 1
Characteristic Comparison According to Change in Composition of Electrolyte Solution

| | Control Group 1 | | Control Group 2 | | Control Group 3 | | Example 1 | |
|---|---|---|---|---|---|---|---|---|
| Division | Capacitance | Resistance | Capacitance | Resistance | Capacitance | Resistance | Capacitance | Resistance |
| 25□ | 3.15 | 0.53 | 3.05 | 0.59 | 3.25 | 0.42 | 3.3 | 0.32 |
| −40□ | 1.32 | 5.7 | 0.76 | 8.85 | 1.46 | 4.62 | 1.81 | 2.88 |
| Change | 41.9 | 1075 | 24.9 | 1500 | 44.9 | 1100 | 54.9 | 900 |
| Ratio (%) | | | | | | | | |

As shown in Table 1, an energy storage device including an electrolyte solution composition according to Example 1 of the present invention could implement a capacitance at a low temperature (−40°C.) corresponds to 54.9% of a capacitance at a room temperature (25° C.) and maintain a resistance at a low temperature (−40° C.) corresponding to 9 times or less of a resistance at a room temperature (25° C.).

On the other hand, it could be confirmed that in the case of Control Groups, only a capacitance at a low temperature corresponding to at most 44.9% of a capacitance at a room temperature was maintained, and a resistance at a low temperature was increased to 10 time or more of a resistance at a room temperature.

### Experimental Example 2

In Experimental Example 2, capacitance and resistance characteristics according to a temperature were compared under the same conditions as those of Experimental Example 1 using mixtures of EC, PC and MP having different composition ratios as a solvent of an electrolyte solution.

(Example 1) EC:PC:MP=3:1:4

(Example 2) EC:PC:MP=3:2:3

(Example 3) EC:PC:MP=3:3:2

Results shown in the following Table 2 were obtained by measuring capacitances (F) and resistances Ω at temperatures of 25° C. and −40° C. with respect to Examples 1 to 3.

TABLE 2
Characteristic Comparison According to Change in Solvent Content Ratio

| | Example 1 | | Example 2 | | Example 3 | |
|---|---|---|---|---|---|---|
| Division | Capacitance | Resistance | Capacitance | Resistance | Capacitance | Resistance |
| Characteristics | (F) | (Ω) | (F) | (Ω) | (F) | (Ω) |
| 25□ | 3.3 | 0.32 | 3.1 | 0.34 | 2.9 | 0.37 |
| −40□ | 1.81 | 2.88 | 1.32 | 3.34 | 1.01 | 3.68 |
| Change | 54.9 | 900 | 42.6 | 982 | 34.4 | 995 |
| Ratio (%) | | | | | | |

As shown in Table 2, an energy storage device including an electrolyte solution composition according to Example 1 of the present invention could implement a capacitance at a low temperature (−40° C.) corresponding to 54.9% of a capacitance at a room temperature (25° C.) and maintain a resistance at a low temperature (−40° C.) corresponding to 9 times or less of a resistance at a room temperature (25° C.).

On the other hand, in the case of Example 2, only a capacitance at a low temperature (−40° C.) corresponding to 42.6% of a capacitance at a room temperature (25° C.) could be implemented, and a resistance at a low temperature (−40° C.) corresponding to 9.82 times or less of a resistance at a room temperature (25° C.) could be maintained.

In addition, in the case of Example 3, only a capacitance at a low temperature (−40° C.) corresponding to 34.4% of a capacitance at a room temperature (25° C.) could be implemented, and a resistance at a low temperature (−40° C.) corresponding to 9.95 times or less of a resistance at a room temperature (25° C.) could be maintained.

Therefore, it could be confirmed that optimal performance may be deduced when a content ratio of a solvent is set to EC:PC:MP=3:1:4 as in Example 1.

Meanwhile, when the electrolyte solution composition according to the present invention is used in a lithium ion capacitor, an effect thereof is maximized.

The electrolyte solution composition according to the exemplary embodiment of the present invention may be used, as an operating electrolyte solution of a lithium ion capacitor, balancedly maintain characteristics at a room temperature and a low temperature, and have excellent wettability for an electrode material and low reactivity to an electrode active material.

In addition, the electrolyte solution composition according to the exemplary embodiment of the present invention is used for pre-doping lithium ions, thereby making it possible to improve pre-doping efficiency.

Further, the electrolyte solution composition according to the exemplary embodiment of the present invention may more easily dissociate the lithium salt, suppress the rise in the viscosity of the electrolyte solution, and increase the electric conductivity of the electrolyte solution.

Furthermore, the energy storage device according to the exemplary embodiment of the present invention has an increased temperature range in which it may be stably and efficiently used and does not cause a relative large increase in a resistance even at a low temperature, thereby making it possible to maintain high output characteristics.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electrolyte solution composition of an energy storage device, the electrolyte solution composition containing:
a lithium salt including lithium ions; and
a solvent made of a material selected from a group consisting of at least one cyclic carbonate compound and propionate compound.

2. The electrolyte solution composition according to claim 1, wherein the lithium salt contains at least any one of LiPF₆, LiBF₄, LiSbF₆, LiAsF₅, LiClO₄, LiN, CF₃SO₃, and LiC.

3. The electrolyte solution composition according to claim 1, wherein the lithium salt is 1.0 mol/L to 1.5 mol/L of LiPF₆.

4. The electrolyte solution composition according to claim 1, wherein the solvent contains ethylene carbonate (EC), propylene carbonate (PC), and methyl propionate (MP).

5. The electrolyte solution composition according to claim 4, wherein the ethylene carbonate, the propylene carbonate, and the methyl propionate have a weight ratio of 3±0.05:1±0.02:4±0.05.

6. An energy storage device comprising:
a case;
an anode and a cathode disposed to be spaced apart from each other in an inner portion of the case;
a separator separating the anode and the cathode from each other in the inner portion of the case; and
an electrolyte solution composition filled in the inner portion of the case,
wherein the electrolyte solution composition contains:
a lithium salt including lithium ions; and
a solvent made of a material selected from a group consisting of at least one cyclic carbonate compound and propionate compound.

7. The energy storage device according to claim 6, wherein the lithium salt contains at least any one of LiPF₆, LiBF₄, LiSbF₆, LiAsF₅, LiClO₄, LiN, CF₃SO₃, and LiC.

8. The energy storage device according to claim 6, wherein the lithium salt is 1.0 mol/L to 1.5 mol/L of LiPF₆.

9. The energy storage device according to claim 6, wherein the solvent contains ethylene carbonate (EC), propylene carbonate (PC), and methyl propionate (MP).

10. The energy storage device according to claim 9, wherein the ethylene carbonate, the propylene carbonate, and the methyl propionate have a weight ratio of 3±0.05:1±0.02:4±0.05.
